(19) United States
(12) Patent Application Publication
(10) Pub. No.: US 2018/0178934 A1
(43) Pub. Date: Jun. 28, 2018

(54) ULTRASONIC CABLE TIE SYSTEM

(71) Applicant: Gulfstream Aerospace Corporation, Savannah, GA (US)

(72) Inventors: Craig Buckthal, Savannah, GA (US); Terry Foss, Savannah, GA (US); Steven Firra, Savannah, GA (US); Manuel Rosas, Savannah, GA (US); Roberto Carlos Cota Magallanes, Savannah, GA (US)

(21) Appl. No.: 15/388,190

(22) Filed: Dec. 22, 2016

(51) Int. Cl. B65B 13/32; B65B 13/10; B65B 27/06; B65B 13/22; B65B 61/00; B29C 65/08; B29C 53/36; B29C 65/00

(52) U.S. Cl. CPC B65B 13/325; B65B 13/10; B65B 27/06; B65B 13/22; B29L 2031/707; B29C 65/08; B29C 53/36; B29C 66/532; B65B 61/005

(57) ABSTRACT

An ultrasonic cable tie system is disclosed herein. The ultrasonic cable tie system includes a housing having a tying portion for receiving a bundle of wires to be tied into a cable. The tying portion has an aperture for dispensing a cable lacing filament from a filament spool and for receiving a free end of the cable lacing filament after being positioned around the bundle of wires. The ultrasonic cable tie system also includes a controller coupled to a tensioning member for tightening the cable lacing filament, an ultrasonic welder for fusing the cable lacing filament, and a filament cutting device for cutting the cable lacing filament. The ultrasonic cable tie system is activated by a system actuator causing the controller to secure the bundle of wires together into the cable with the cable lacing filament having a flat fused portion adjacent to a surface of the cable.

### TECHNICAL FIELD

The present invention generally relates to cable tying systems, and more particularly relates to an ultrasonic cable tying system suitable for use on aircraft cables.

### BACKGROUND

Contemporary business aircraft require sophisticated navigation, flight control and flight support units to provide safe air transportation. These and other systems onboard the aircraft are powered and interconnected by miles of wire, most of which is bundled into cables. Typically, a bundle of wires is tied together to form a cable. Referring to FIGS. 1A-F, a cable tying (also referred to as lacing) procedure 100 approved by the FAA (Federal Aviation Authority) is shown. To secure a bundle of wires 102 into a cable, a technician first ties cable lacing filament 104 (also known as tape or lace) to form a clove hitch 106 (FIG. 1D) by following the steps illustrated in FIGS. 1A-C. The clove hitch 106 is then finished into a securing knot (FIG. 1F) by first tying a square knot 108 followed by a surgeons knot 110 (FIG. 1E). Typically, the cable lacing filament 104 must meet strict standards established by the FAA for aircraft applications such as MIL-T-43435.

While useful and effective, manually tying the miles of wire used in contemporary aircraft into cables is laborious and repetitive work. Even skilled technicians require approximately thirty seconds to tie a single knot, which must be repeated periodically (e.g., every 6 inches) along the entire length of the cable. Moreover, since the cable knots 112 protrude from the contoured surface of the cable, the cable knots 112 can interfere with the cable being pulled along cable passageways in the aircraft. Similarly, the cable knots 112 also complicate the placement of a cable sheath over the finished cable.

One alternative to individually tying cable knots is to use conventional cable ties as illustrated in FIGS. 2A-B. In the conventional cable tie process 200, wire bundles 202 are encircled by the cable tie 204 that includes a gripping head 206 (also known as the strap boss). A free end 208 of the cable tie passes through the strap boss and can be tightened by hand or by using handheld tools as is known in the art. The excess free end 208 is then cut away and discarded. While also useful and effective, conventional cable ties are relatively expensive compared to cable lacing filament and a variety of fixed lengths of cable ties must be maintained in inventory to be available to the technicians. Additionally, the strap boss 206 protrudes an even greater amount from the cable surface than a cable knot, which further complicates positioning the cable through cable passageways or the installation of a cable sheath.

Accordingly, it is desirable to provide an improved method for tying wire bundles into cables suitable for use on aircraft. It is further desirable to provide a tool to perform the method that simplifies the cable lacing procedure thereby affording an advantage in technician time, reduced cost and reduction of waste to provide cables for use on aircraft. Furthermore, other desirable features and characteristics will become apparent from the subsequent detailed description and the appended claims, taken in conjunction with the accompanying drawings and the foregoing technical field and background.

### BRIEF SUMMARY

Exemplary embodiments of an ultrasonic cable tying system are disclosed herein.

In a first non-limiting embodiment, an ultrasonic cable tie system includes, but is not limited to, a housing having a tying portion for receiving a bundle of wires to be tied into a cable. The tying portion has an aperture for dispensing a cable lacing filament from a filament spool and for receiving a free end of the cable lacing filament after being positioned around the bundle of wires. The ultrasonic cable tie system also includes, but is not limited to, a controller coupled to a tensioning member for tightening the cable lacing filament, an ultrasonic welder for fusing the cable lacing filament after being tightened by the tensioning member, and a filament cutting device for cutting the cable lacing filament after being fused by the ultrasonic welder. The ultrasonic cable tie system is activated by a system actuator causing the controller to secure the bundle of wires together into the cable with the cable lacing filament having a flat fused portion adjacent to a surface of the cable.

In a second non-limiting embodiment, a method is provided for tying a bundle of wires into a cable via ultrasonic cable tie system. The method includes, but is not limited to, extracting a cable lacing filament from the ultrasonic cable tying system and wrapping the cable lacing filament around the bundle of wires. Next, a free end of the cable lacing filament is inserted into the ultrasonic cable tying system. The ultrasonic cable tying system is activated to tighten the cable lacing filament around the bundle of wires, ultrasonically fuse the cable lacing filament to secure the bundle of wires into the cable, and cut the cable lacing filament to free the cable from the ultrasonic cable tying system. This provides a bundle of wires securely tied together into a cable with the cable lacing filament having a flat fused portion adjacent to a surface of the cable.

### BRIEF DESCRIPTION OF THE DRAWINGS

The present invention will hereinafter be described in conjunction with the following drawing figures, wherein like numerals denote like elements, and

FIGS. 1A-F are illustrations of a conventional cable lacing procedure;

FIGS. 2A-B are illustrations of a conventional cable tie procedure;

FIG. 3 is a block diagram illustrating a non-limiting embodiment of a cable tie system suitable for use in accordance with the teachings of the present disclosure;

FIGS. 4A-C are illustrations of some of the advantages of non-limiting embodiments of the cable tying procedure in accordance with the teachings of the present disclosure;

FIG. 5 is a cutaway side view illustrating a non-limiting embodiment of the tensioning member of FIG. 3 in accordance with the teachings of the present disclosure;

FIGS. 6A-B are diagrams illustrating a non-limiting embodiment of the cable tie system of FIG. 3 in a mobile and fixed-structure embodiment in accordance with the teachings of the present disclosure;

FIG. 7 is a cross-section side view illustrating a non-limiting embodiment of a portable hand-held embodiment of the cable tie system in accordance with the teachings of the present disclosure; and

FIG. 8 is a flow diagram illustrating a non-limiting method in accordance with the teachings of the present disclosure.

### DETAILED DESCRIPTION

As used herein, the word “exemplary” means “serving as an example, instance, or illustration.” The following detailed description is merely exemplary in nature and is not intended to limit application and uses. Any embodiment described herein as “exemplary” is not necessarily to be construed as preferred or advantageous over other embodiments. All of the embodiments described in this Detailed Description are exemplary embodiments provided to enable persons skilled in the art to make or use the embodiment and not to limit the scope that is defined by the claims. Furthermore, there is no intention to be bound by any expressed or implied theory presented in the preceding Technical Field, Background, Drawings Summary or the following Detailed Description.

An ultrasonic cable tie system is disclosed herein that provides advantages in reduced tying operation time as well as reduced waste. The ultrasonic cable tie system can be permanently attached to a fixed structure, coupled to a mobile cart, or can be configured as a handheld device. While the ultrasonic cable tie system of the present disclosure is described as affording an advantage in an aircraft application, it will be appreciated that the present disclosure may be advantageously employed in other applications, including but not limited to, cable assemblies for ground based vehicles, watercraft and spacecraft without departing from the teachings of the present disclosure.

A greater understanding of the ultrasonic cable tie system described above may be obtained through a review of the illustrations accompanying this application together with a review of the Detailed Description that follows.

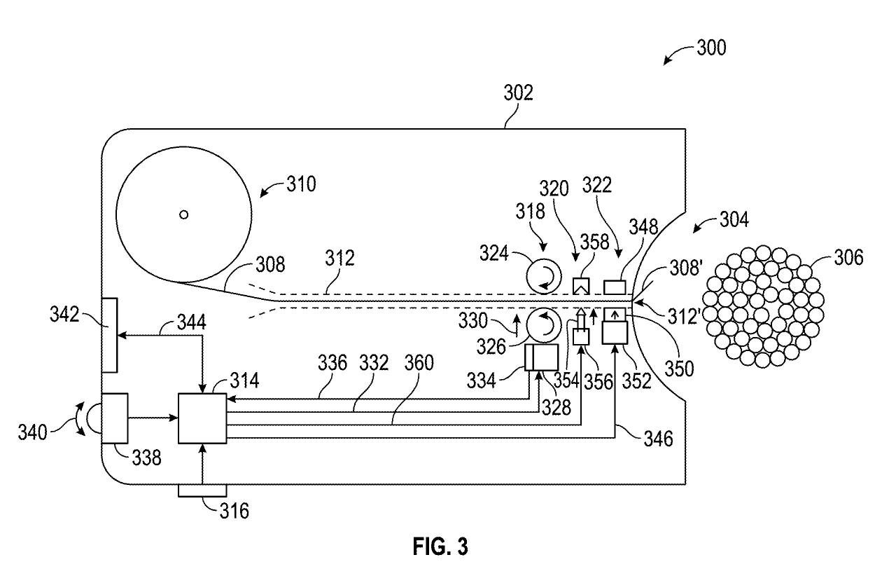

FIG. 3 is a block diagram illustrating a non-limiting embodiment of an ultrasonic cable tie system 300. As illustrated in the exemplary embodiment of FIG. 3, the ultrasonic cable tie system 300 includes a housing 302 having a tying portion 304 formed therein to receive a bundle of wires 306 to be tied into a cable. According to exemplary embodiments, the cable tying portion 304 has a generally arcuate shape to receive various sizes of wire bundles to be formed into cables. Cable lacing filament 308 is provided by a spool 310 that will be wrapped around the wire bundle 306 and secured as discussed below. The cable lacing filament 308 is provided to an aperture 312′ in the tying portion 304 by a cable filament channel 312 formed in the housing 302. As will be appreciated by those skilled in the art, a cable lacing filament compliant with MIL-T-43435 will be sufficiently stiff to be manually feed through the cable filament channel 312 to the aperture 312′.

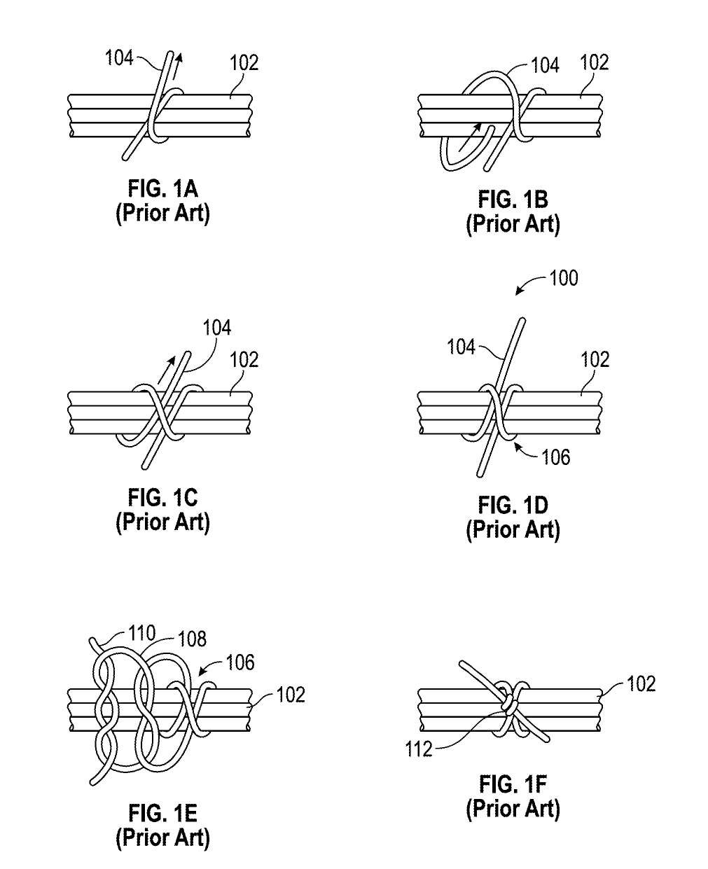

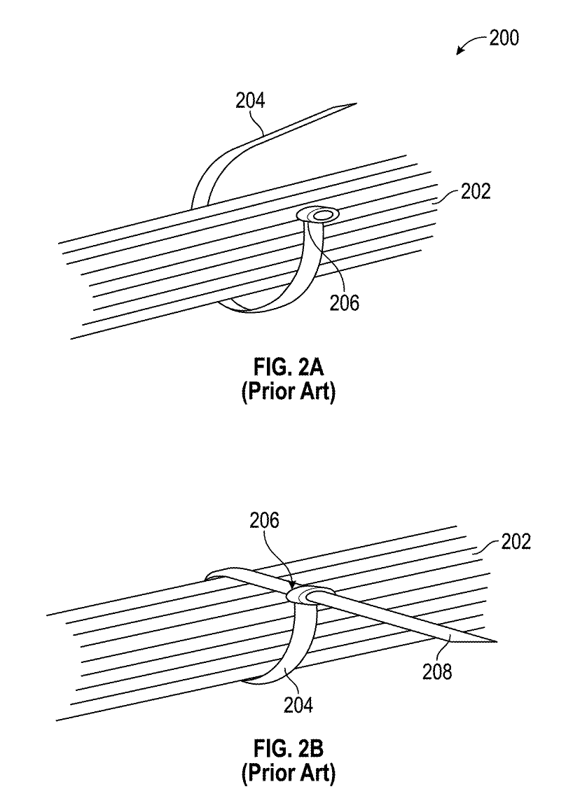

The operation of the ultrasonic cable tie system 300 is controlled by a processor or controller 314, which activates the system 300 responsive to a system actuator 316. Prior to activating the system actuator 316, a technician would extract the cable lacing filament 308 from the tying portion 304 of the ultrasonic cable tie system 300 and wrap it around the wire bundle 306. In some embodiments, the cable lacing filament 308 is wrapped a minimum of twice around the wire bundle 306 and may be wrapped around to form a clove hitch as illustrated in FIG. 1D. After wrapping cable lacing filament 308 around the wire bundle 306, a free end 308′ of the cable lacing filament is inserted by the technician into the filament channel prior to activating system actuator 316. Once the system actuator 316 has activated the controller 314, the controller 314 engages a tensioning member 318 to grip and tighten the cable lacing filament 308 around the wire bundle. Once the desired level of tension is achieved, the controller 314 activates an ultrasonic welder 322 to fuse the cable lacing filament to form a secure bond. After the cable lacing filament 308 has been bonded, the controller 314 activates a hot-blade cutter 320 to sever the now tied wire bundle from the ultrasonic cable tie system 300.

In some embodiments, the tensioning member 318 comprises a pair of rollers 324, 326. Roller 326 is controlled by an actuator 328 that moves roller 326 in the direction indicated by arrow 330 responsive to a signal on conduit 332 from the controller 314. This brings roller 326 into contact with roller 324 and then the actuator 328 causes roller 326 to rotate (counterclockwise in this example) to tighten the cable lacing filament 308 that has been previously wrapped around the wire bundle 306 by the technician. As the cable lacing filament is tightened, the wire bundle 306 is brought firmly into the tying area 304 while the rollers 324 and 326 continually apply an increasing force to the cable lacing filament. A tension sensor 334 communicates the tension applied to the cable lacing filament 308 to the controller 313 via conduit 336. In some embodiments, the desired level of tension applied to cable lacing filament 308 is set by the technician using a tension adjustment 338 that can be moved to increase or decrease the applied tension as indicated by arrow 340. In other embodiments, the desired tension can be set from a touch sensitive display 342 that provides the tension setting to the controller 314 via conduit 344. In the embodiment illustrated in FIG. 3, the roller 324 is “freewheeling” and the roller 326 provides the drive and tensioning operation via actuator 328. In other embodiments, both the roller 324 and roller 326 could have actuators that operate to move the rollers 324, 326 in tandem to tighten the cable lacing filament 308 as will be appreciated by those skilled in the art.

Once the desired level of tension has been applied to the cable lacing filament 308, the controller 314 activates an ultrasonic welder 322 via conduit 346. Ultrasonic welder 322 includes an anvil 348 and a horn 350 that is brought into contact with the anvil 348 via an actuator 352. The actuator 352 causes the horn 350 to vibrate generating sufficient heat to fuse the cable lacing filament 308. In some embodiments, the horn vibrates at a rate between 15 kHz and 75 kHz to fuse the cable lacing filament 308.

After the cable lacing filament 308 has been fused by the ultrasonic welder 322, the controller 314 activates a filament cutting device 322 via conduit 360 to sever the cable lacing filament and free the tied wire bundle 306 from the ultrasonic cable tie system 300. In some embodiments, the filament cutting device 322 includes a hot-blade cutter 354 that is electrically heated and moved by an actuator 356 into contact with a cutting surface 358 to sever the cable lacing filament 308. The hot-blade cutter 354 provides an advantage in that in addition to severing the cable lacing filament, it also fuses the free end of the cable lacing filament to the filament supplied by the spool 310 which facilitates preparing the ultrasonic cable tie system 300 for the next operation as will be discussed below. In embodiments employing a cutter other than a hot-blade cutter, the rollers 324 and 326 will eject the cut free end 308′ through the aperture 312′ provided that a sufficient length of the free end 308′ has been inserted past the roller pair 324 and 326 to be pushed out the aperture 312′.

Once the wire bundle 360 has been securely tied and released by the ultrasonic cable tying system 300, the controller 314 can update a counter displayed on display 342 providing a tally of the total number of ties positioned on wire bundle 306. This provides an advantage of assuring that cable wiring harnesses have received the proper number of ties to comply with specifications in any particular implementation.

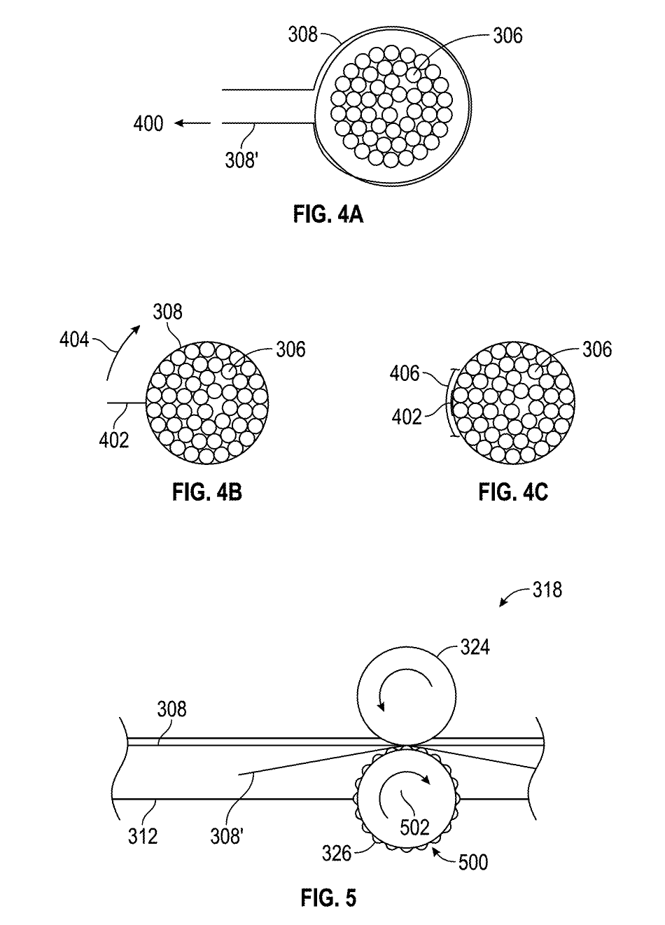

With continued reference to FIG. 3, FIGS. 4A-C illustrate the advantages of the cable tying procedure of the present disclosure. In FIG. 4A, the wire bundle 306 can be seen to have been wrapped twice around its circumference by the cable lacing filament 308 and a free end 308′ being available to be inserted into the filament channel 312 prior to activation of the ultrasonic cable tie system 300. After the ultrasonic cable tie system 300 has tightened, fused, and cut the cable lacing filament 308, the wire bundle 306 is securely tied as illustrated in FIG. 4B. In addition to being a faster process with less waste than the hand tying procedure of FIGS. 1A-F, the ultrasonic cable tie system 300 of the present disclosure provides a flat fused “tie” portion 304 that can be placed substantially flush (flat against) the surface contour of wire bundle 306 by pressing the fused portion 402 in the direction indicated by arrow 404 as illustrated in FIG. 4C. As will be appreciated by those skilled in the art, having the fused portion 402 position flush against the wire bundle 306 facilitates the installation of a cable sheath 406 and/or positioning the tied cable along cable passageways in an aircraft.

With continued reference to FIG. 3, FIG. 5 is a cutaway side view of the tensioning member 318 to facilitate understanding of how the ultrasonic cable tie system 300 is prepared for a next cable tie operation. As illustrated in FIG. 5, the roller 326 has been brought into contact with roller 324 and has previously moved in a counterclockwise direction to tighten the cable lacing filament 308 as described above. Once the filament cutting device 320 has freed the wire bundle 306, the roller 326 reverses direction as indicated by arrow 502 causing the cable lacing filament 308 supplied from the spool 310 to move towards the aperture in the tying area 304 so that the technician may perform the next tying operation. In some embodiments, at least the roller 326 has a textured or contoured surface 500 to provide additional gripping capability. As mentioned above, in some embodiments the filament cutting device includes a hot-blade cutter 354 that will cause the free end of the cable lacing filament 308′ to fuse to the cable lacing filament 308 from the spool 310 as the cable lacing filament is severed from the spool 310. This causes the unused portion (or tail) of the free end 308′ to travel with the cable lacing filament 308 through the filament channel 312 to the aperture in the tying portion 304 as the cable lacing filament 308 from the spool 310 is fed forward by the rollers for the next tying operation. The unused portion of the free end 308′ can be separated and discarded by the technician prior to performing the next tie operation using the cable lacing filament 308.

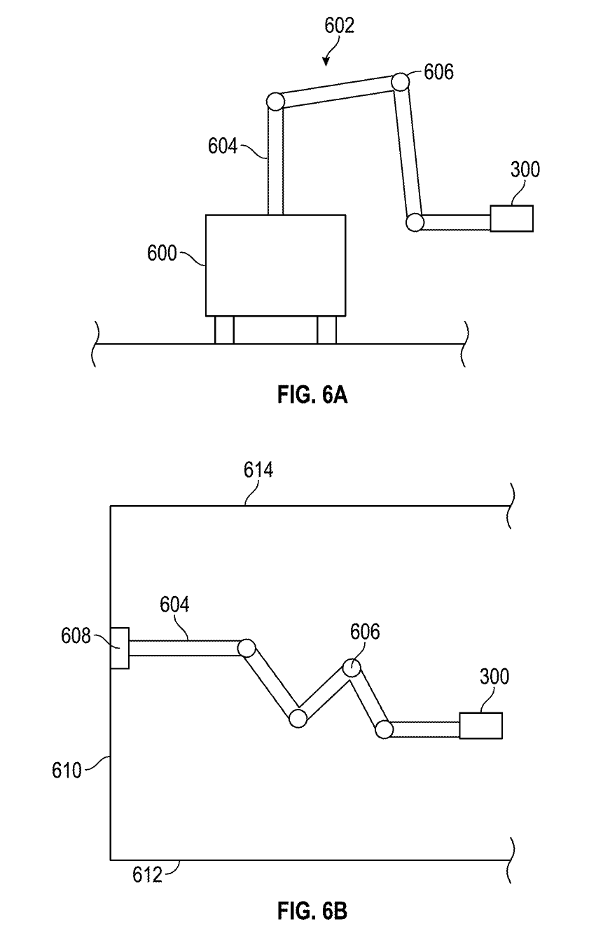

Referring now to FIGS. 6A-B, the ultrasonic cable tie system 300 can be seen (FIG. 6A) coupled to a mobile cart 600 via an articulating arm 602. The articulating arm 602 includes arm portion 604 and joints 606 is needed in any particular implementation for a technician to readily position the ultrasonic cable tie system 300 for operation. In this embodiment, any necessary power supply for the ultrasonic cable tie system 300 could be housed in the mobile cart 600 and power provided through the articulating arm 602 as will be appreciated by those skilled in the art. FIG. 6B illustrates a fixed embodiment where the ultrasonic cable tie system 300 is coupled by a fastener 608 to a fixed surface such as a wall 610, floor 612 or ceiling 614.

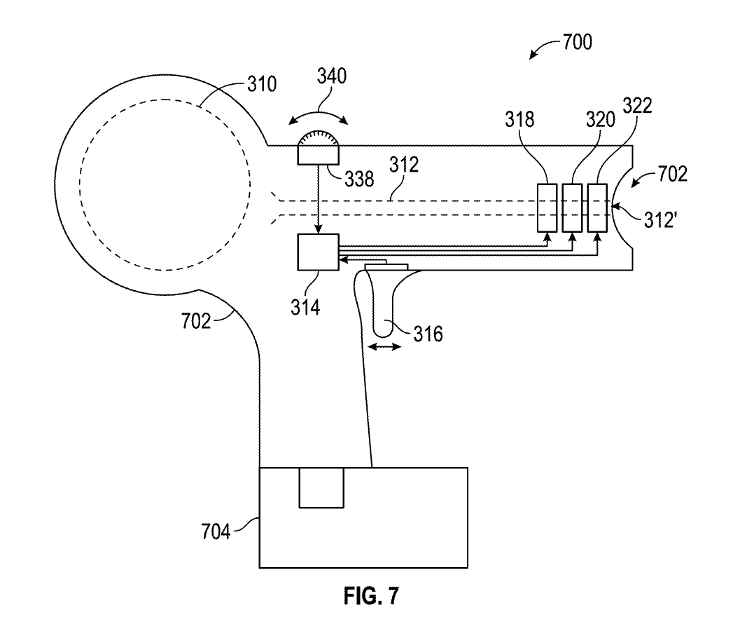

FIG. 7 illustrates a portable handheld embodiment of a ultrasonic cable tie system 700. The system 700 has a hand-holdable (pistol grip) housing 702 that couples to a detachable and rechargeable battery 704. In a similar operating manner to the ultrasonic cable tie system 300 of FIG. 3, the controller 314 would activate the system 700 upon the system actuator 316 being activated by a technician causing the tensioning member 318 to tighten the cable lacing filament, the ultrasonic welder 322 to fuse the cable lacing filament and the filament cutting device 322 to sever the cable lacing filament so that the tied wire bundle can be freed from the system 700.

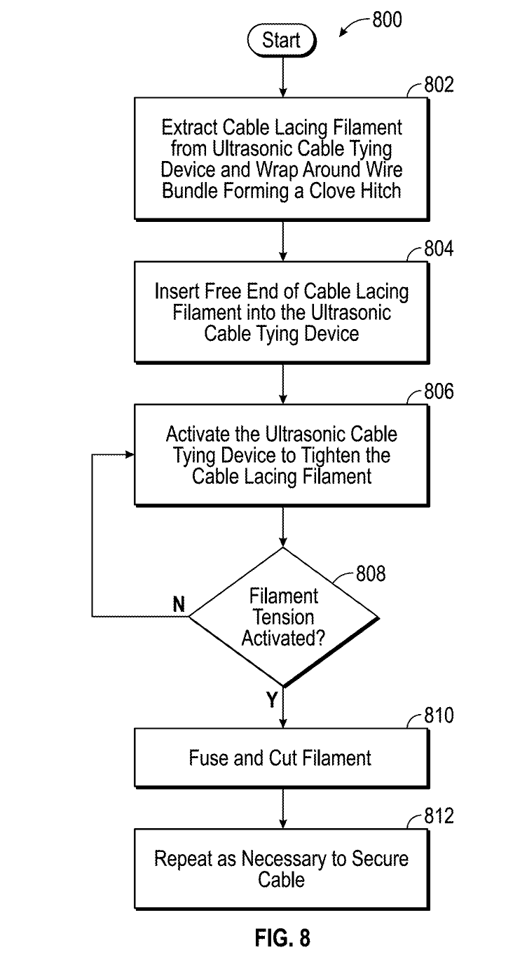

FIG. 8 illustrates a non-limiting method 800 for operating the ultrasonic cable tie system of the present disclosure. In block 802, a technician would extract the cable lacing filament from the ultrasonic cable tying device and wrap it around the wire bundle preferably twice, and in some embodiments, forming a clove hitch. In block 802 the technician inserts the free end of the cable lacing filament back into the ultrasonic cable tying system. The technician then activates the ultrasonic cable tying system in block 306 causing the cable lacing filament to be securely tightened around the wire bundle. In block 808, the controller determines whether or not the desired level of filament tension has been achieved. If not, the controller continues to activate the tensioning member and further tighten the cable lacing filament. Once block 808 determines that the cable lacing filament tension has been achieved, the cable lacing filament is fused and cut in block 810 and then the technician repeats the process as needed in block 812 to completely secure the wire bundle into a cable.

It will be appreciated that skilled artisans may implement the described functionality of an ultrasonic cable tie system in varying ways for each particular application, but such implementation decisions should not be interpreted as causing a departure from the scope as set forth in the claims.

In this document, relational terms such as first and second, and the like may be used solely to distinguish one entity or action from another entity or action without necessarily requiring or implying any actual such relationship or order between such entities or actions. Numerical ordinals such as first, second, third,” etc. simply denote different singles of a plurality and do not imply any order or sequence unless specifically defined by the claim language. The sequence of the text in any of the claims does not imply that process steps must be performed in a temporal or logical order according to such sequence unless it is specifically defined by the language of the claim. The process steps may be interchanged in any order without departing from the scope of the invention as long as such an interchange does not contradict the claim language and is not logically nonsensical.

Furthermore, depending on the context, words such as connect or coupled to that are used in describing a relationship between different elements does not imply that a direct physical connection must be made between these elements. For example, two elements may be connected to each other physically, electronically, logically, or in any other manner, through one or more additional elements.

While at least one exemplary embodiment has been presented in the foregoing detailed description of the disclosure, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention. It being understood that various changes may be made in the function and arrangement of elements described in an exemplary embodiment without departing from the scope of the disclosure as set forth in the appended claims.

What is claimed is:

1. An ultrasonic cable tie system, comprising:
a housing having a tying portion for receiving a bundle of wires to be tied into a cable, the tying portion having an aperture for dispensing a cable lacing filament and for receiving a free end of the cable lacing filament after being positioned around the bundle of wires;
a filament spool, coupled to the housing, for supplying the cable lacing filament through a filament channel in the housing to the first aperture;
a tensioning member disposed adjacent to the filament channel for tightening the cable lacing filament after the free end of the cable lacing filament has been positioned around the bundle of wires and into the second aperture;
an ultrasonic welder disposed adjacent to the filament channel for fusing the cable lacing filament after being tightened by the tensioning member;
a filament cutting device for cutting the cable lacing filament after being fused by the ultrasonic welder;
a controller coupled to the tensioning member, the ultrasonic welder and the filament cutting device; and
a system actuator coupled to the controller, that when activated, causes the controller to:
activate the tensioning member to tighten the cable lacing filament around the bundle of wires;
activate the ultrasonic welder while the cable lacing filament is tightened by the tensioning member to fuse the cable lacing filament; and
activate the filament cutting device to cut the cable lacing filament after being fused by the ultrasonic welder;
wherein, the bundle of wires is tied together into the cable by the cable lacing filament having a flat fused portion adjacent to a surface of the cable.

2. The system of claim 1, wherein the free end of the cable lacing filament positioned around the bundle of wires by twice looping the cable lacing filament around the bundle of wires.

3. The system of claim 2, wherein the free end of the cable lacing filament positioned around the bundle of wires by twice looping the cable lacing filament to form a clove hitch around the bundle of wires.

4. The system of claim 1, wherein the tensioning member comprises a pair of rollers positioned on either side of the filament channel.

5. The system of claim 4, wherein at least one of the pair of rollers has a contoured surface.

6. The system of claim 1, further comprising a tension adjustment control coupled to the controller.

7. The system of claim 1, wherein the ultrasonic welder comprises an anvil and a horn positioned on either side of the filament channel.

8. The system of claim 1, wherein the ultrasonic welder vibrates between approximately 15 kHz and approximately 75 kHz to fuse the cable lacing filament.

9. The system of claim 1, wherein the cutting device comprises a hot cutting blade.

10. The system of claim 1, wherein the housing comprises a hand-holdable housing.

11. The system of claim 10, wherein the hand-holdable housing comprises a pistol-grip housing.

12. The system of claim 1, wherein the tying portion of the housing has an arcuate shape for receiving the bundle of wires.

13. The system of claim 1, further comprising an articulable arm coupled at one end to the housing and at another end to a stationary or mobile fixture.

14. An ultrasonic cable tie system, comprising:
a housing having a tying portion for receiving a bundle of wires to be tied into a cable, the tying portion having an aperture for dispensing a cable lacing filament and for receiving a free end of the cable lacing filament after being positioned around the bundle of wires twice to form a clove hitch;
a filament spool, coupled to the housing, for supplying the cable lacing filament through a filament channel in the housing to the first aperture;
a tensioning member positioned on either side of the filament channel, the tensioning member comprising a pair of rollers for tightening the cable lacing filament after the free end of the cable lacing filament has been positioned around the bundle of wires and into the second aperture;
an ultrasonic welder positioned on either side to the filament channel, the ultrasonic welder comprising an anvil and a horn for fusing the cable lacing filament after being tightened by the tensioning member;
a filament cutting device for cutting the cable lacing filament after being fused by the ultrasonic welder;
a controller coupled to the tensioning member, the ultrasonic welder and the filament cutting device; and
a system actuator coupled to the controller, that when activated, causes the controller to:
activate the tensioning member to tighten the cable lacing filament around the bundle of wires;
activate the ultrasonic welder while the cable lacing filament is tightened by the tensioning member to fuse the cable lacing filament; and
activate the filament cutting device to cut the cable lacing filament after being fused by the ultrasonic welder;
wherein, the bundle of wires is tied together into the cable by the cable lacing filament having a flat fused portion adjacent to a surface of the cable.

15. The system of claim 14, wherein at least one of the pair of rollers has a contoured surface.

16. The system of claim 14, wherein the ultrasonic welder vibrates between 15 kHz and 75 kHz to fuse the cable lacing filament.

17. The system of claim 14, further comprising a tension adjustment control coupled to the controller.

18. The system of claim 14, further comprising an articulable arm coupled at one end to the housing and at another end to a stationary or mobile fixture.

19. A method for tying a bundle of wires into a cable, comprising:
extracting a cable lacing filament from a cable tying device;
wrapping the cable lacing filament around the bundle of wires twice to form a clove hitch;
inserting a free end of the cable lacing filament into the cable tying device;
activating the cable tying device to tighten the cable lacing filament around the bundle of wires;
ultrasonically fusing the cable lacing filament to secure the bundle of wires into the cable; and
cutting the cable lacing filament to free the cable from the cable tying device;
wherein, the bundle of wires is tied together into the cable by the cable lacing filament having a flat fused portion adjacent to a surface of the cable.

20. The method of claim 19, further comprising:
positioning the flat fused portion of the cable lacing filament flush with the surface of the cable; and
positioning a cable sheath over the cable and the fused portion of the cable lacing filament;
whereby, the flat fused portion of the cable lacing filament does not impede the positioning of the cable sheath over the cable.
